(19) United States
(12) Patent Application Publication
(10) Pub. No.: US 2003/0081092 A1
(43) Pub. Date: May 1, 2003

(54) Aqueous dispersion of colored particles, process for producing the same and ink for ink-jet recording

(76) Inventors: Takahiro Ishizuka, Kanagawa (JP); Kazue Sano, Kanagawa (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/145,809

(22) Filed: May 16, 2002

(30) Foreign Application Priority Data
May 17, 2001 (JP) P.2001-147986
Jan. 21, 2002 (JP) P.2002-11645

(51) Int. Cl. G01D 11/00

(52) U.S. Cl. 347/100

(57) ABSTRACT

An aqueous dispersion of colored particles, the dispersion comprising: a water-insoluble colorant; an aqueous medium; a polymer obtained by a vinyl monomer; and a dispersant, wherein the dispersion has a high dispersion stability when the water-insoluble colorant is dispersed in the presence of the dispersant, and a latex having a poor dispersion stability is formed when the vinyl monomer is polymerized in the presence of the dispersant alone.

### FIELD OF THE INVENTION

This invention relates to aqueous dispersions of colored fine particles containing water-insoluble colorants and inks for ink-jet recording with the use of the aqueous dispersions of the colored fine particles.

### BACKGROUND OF THE INVENTION

Known inks for ink-jet recording involve oily inks, water inks and solid inks. Among all, water inks have been mainly employed because of being advantageous from the viewpoints of, for example, easiness in production, handling properties, odor and safety.

Although water inks containing water-soluble dyes have merits of being highly transparent and achieving a high color density, they suffer from some problems such as frequently blurring on ordinary papers, having a poor water-proofness and showing an insufficient light-fastness.

To overcome these problems, attempts have been made to employ water-insoluble colorants such as pigments and dispersible dyes. However, the inks thus obtained are poor in the clarity of color tones and transparency and show only insufficient dispersion stability upon prolonged storage. In case of using recording papers having an ink-receiving layer containing porous fine inorganic particles on the surface (hereinafter referred to as “photographic image papers”) which have been recently employed with the increasing tendency toward high-quality images, there arise some additional troubles such that only an insufficient fretting resistance can be obtained and metallic luster (bronze) is sometimes observed due to the regular reflection light on the pigment particle surface.

On the other hand, it has been also attempted to improve the dispersion stability and the discharge stability of fine colorant particles by coating the surface of water-insoluble colorants with polymerizable surfactants or polymers containing vinyl monomers.

Japanese Patent Laid-Open No. 316909/1998 proposes a method wherein a polymerizable surfactant and a pigment are dispersed in water and then a polymerization initiator is added to thereby fix the surfactant on the surface of the pigment. In case of using a polymerizable surfactant, however, the dispersibility is frequently worsened, which makes it difficult to give a dispersion of fine pigment particles. In case of using a vinyl monomer together therewith in order to, for example, improve the fretting resistance, there arises another problem that the particles are liable to undergo aggregation in the course of the polymerization.

Japanese Patent Laid-Open No. 12512/1999 proposes a method wherein a pigment is added to a polymerizable unsaturated monomer and then a surfactant and water are added to perform emulsion polymerization. To obtain a fine dispersion by this method, it is necessary to finely disperse oil droplets before the emulsion polymerization. Thus, there arise some problems such that aggregation frequently occurs in the course of the polymerization.

As discussed above, there has been provided hitherto no dispersion of colored fine particles which is excellent in handling properties, odor and safety, has a small particle size of the dispersed particles, shows a high dispersion stability and a high storage stability of the dispersion, and in case of using in inks, shows a high discharge stability without causing clogging on nozzle tip, has no paper-dependency, achieves an excellent water-proofness and light-fastness after printing, shows an excellent fretting resistance even in case of using the photographic image papers as described above, shows little metallic luster and enables highly dense recording with high image qualities.

### SUMMARY OF THE INVENTION

The invention aims at solving the problems encountering in the related art as described above and achieving the following objects.

Namely, the invention aims at providing dispersions of colored fine particles which are excellent in handling properties, odor and safety and appropriate for writing water inks, printing water inks and inks for data recording, have a small particle size of the dispersed particles and show a high dispersion stability and a high storage stability.

The invention further aims at providing inks for ink-jet recording which are appropriate for thermal, piezoelectric, electric field or acoustic ink-jet systems and excellent-in handling properties, odor and safety, have a small particle size of the dispersed particles, show a high dispersion stability and a high storage stability, scarcely cause clogging in nozzle tips, have no paper-dependency, achieve an excellent water-proofness and light-fastness after printing, show an excellent fretting resistance even in case of using the photographic image papers as described above, show little metallic luster and enable highly dense recording with high image qualities.

Methods for solving these problems are as follows.

1. An aqueous dispersion of colored fine particles which is an aqueous dispersion of the colored fine particles containing a water-insoluble colorant, wherein the dispersion of the colored fine particles is prepared by dispersing the water-insoluble colorant in an aqueous medium in the presence of a dispersant, adding a vinyl monomer and then polymerizing, and the dispersant shows a dispersion stability in case where the water-insoluble colorant is dispersed but forms a latex having a poor stability in case where the vinyl monomer is polymerized in the presence of the dispersant.

2. The aqueous dispersion of colored fine particles as described in 1 wherein the vinyl monomer is made up of a component having an I/O value of 0.05 or more but less than 0.76 and another component having an I/O value of 0.76 or more and the content of the component having an I/O value of 0.76 or more is 2% by mass or more but not more than 30% by mass.

3. An aqueous dispersion of colored fine particles as described in 1 or 2 wherein the polymer obtained from the vinyl monomer has a glass transition temperature of −50° C. or higher but not higher than 80° C.

4. A process for producing an aqueous dispersion of colored fine particles which is an aqueous dispersion of the colored fine particles containing a water-insoluble colorant, wherein the dispersion of the colored fine particles is prepared by dispersing the water-insoluble colorant in an aqueous medium in the presence of a dispersant, adding a vinyl monomer and then polymerizing, and the dispersant shows a dispersion stability in case where the water-insoluble colorant is dispersed but forms a latex having a poor stability in case where the vinyl monomer is polymerized in the presence of the dispersant.

5. An ink for ink-jet recording which is an ink for ink-jet recording containing at least water, a water-soluble organic solvent and a dispersion of colored fine particles, wherein the dispersion of the colored fine particles is prepared by dispersing the water-insoluble colorant in an aqueous medium in the presence of a dispersant, adding a vinyl monomer and then polymerizing, and the dispersant shows a dispersion stability in case where the water-insoluble colorant is dispersed but forms a latex having a poor stability in case where the vinyl monomer is polymerized in the presence of the dispersant.

6. The ink for ink-jet recording as described in 5 which further contains a nonionic surfactant.

7. An ink for ink-jet recording as described in 5 or 6 wherein the vinyl monomer is made up of a component having an I/O value of 0.05 or more but less than 0.76 and an other component having an I/O value of 0.76 or more and the content of the component having an I/O value of 0.76 or more is 2% by mass or more but not more than 30% by mass.

8. An ink for ink-jet recording as described in any of 5 to 7 wherein the polymer obtained from the vinyl monomer has a glass transition temperature of −50° C. or higher but not higher than 80° C.

9. An ink-jet recording method wherein an ink for ink-jet recording as described in any of 5 to 8 is used in recording.

### DETAILED DESCRIPTION OF THE INVENTION

The invention will be illustrated in greater detail. The term “to” as used herein concerning numerical specification means including the numerical values given before and after the same respectively as the minimum and maximum values.

<Production of Dispersion of Colored Fine Particles>

The aqueous dispersion of colored fine particles according to the invention is obtained by dispersing a water-insoluble colorant in an aqueous medium with the use of a dispersant and then adding a vinyl monomer thereto followed by polymerization.

(1) Step of Dispersing Water-Insoluble Colorant

A water-insoluble colorant is dispersed in an aqueous medium in the presence of a dispersant. It is preferable to use a dispersing machine (for example, a ball mill, a sand mill, an attritor, a roll mill, an agitator mill, a Henschel mixer, a colloid mill, an ultrasonic homogenizer, a purl mill, a jet mill, an ang-mill).

The amount of the dispersant to be added may be arbitrarily controlled depending on, for example, the type of the water-insoluble colorant, the type of the dispersant and the desired particle size of the water-insoluble colorant dispersion. It is preferable to add the dispersant in an amount of 5 to 100% by mass, still preferably 10 to 60% by mass, based on the water-insoluble colorant.

In case of using in an ink-jet ink, it is preferable that the particle size (central diameter, 50% diameter) of the water-insoluble colorant dispersion is 1 to 500 nm, still preferably 3 to 300 nm, still preferably 5 to 150 nm and particularly preferably 5 to 100 nm. The average particle size can be controlled by, for example, centrifugation or filtration.

(2) Polymerization Step

To the water-insoluble colorant dispersion, a vinyl monomer and a polymerization initiator are added and then polymerization is performed. The thus obtained water-insoluble colorant dispersion surface-coated with the polymer is regarded as a dispersion of colored fine particles. Alternatively, he polymerization initiator may be preliminarily added to the aqueous medium in the step of dispersing the water-insoluble colorant.

Although either a water-soluble polymerization initiator or a fat-soluble one may be used, it is preferable to use a water-soluble initiator, still preferably a water-soluble heat initiator (for example, a persulfate, an azo compound).

In case of using in an ink-jet ink, it is preferable that the particle size of the dispersion of the colored fine particles is 1 to 500 nm, still preferably 3 to 300 nm, still preferably 5 to 150 nm and particularly preferably 5 to 100 nm. The average particle size can be controlled by, for example, centrifugation or filtration.

Water-Insoluble Colorant:

The term “water-insoluble colorant” as used herein means a colorant which is almost insoluble or hardly soluble in water. Examples thereof include dye such as fat-soluble dyes and disperse dyes, pigments and dyestuffs forming J-aggregates. Disperse dyes, pigments and dyestuffs forming J-aggregates are preferable and pigments are still preferable.

Particularly preferable examples of the fat-soluble dyes include C.I. Solvent Black Series; C.I. Solvent Yellow Series; C.I. Solvent Red Series; C.I. Solvent Violet Series; C.I. Solvent Blue Series; C.I. Solvent Green Series; and C.I. Solvent Orange Series, though the invention is not restricted thereto.

Particularly preferable examples of the disperse dyes include C.I. Disperse Yellow Series; C.I. Disperse Orange Series; C.I. Disperse Red Series; C.I. Disperse Violet Series; C.I. Disperse Blue Series; and C.I. Disperse Green Series, though the invention is not restricted thereto.

As the pigments, publicly known organic and inorganic pigments can be used without restriction in type. Examples thereof include polycyclic pigments such as azo lakes, azo pigments, phthalocyanine pigments, perylene and perinone pigments, anthraquinone pigments, quinacridone pigments, dioxazine pigments, diketopyrrolpyrrole pigments, thioindigo pigments, isoindolinone pigments and quinophthalone pigments, dye lakes such as basic dye lakes and acidic dye lakes, organic pigments such as nitro pigments, nitroso pigments, aniline black and daylight fluorescent pigments, and inorganic pigments such as titanium oxide, iron oxide pigments and carbon black pigments. Moreover, use can be made of any pigment which is not listed in Color Index, so long as it is dispersible in an aqueous phase. In addition, it is needless to say that products obtained by surface-treating the pigments cited above with surfactants or polymer dispersants and graft carbon are usable therefor. Among these pigments, it is particularly preferable to use azo pigments, phthalocyanine pigments, anthraquinone pigments, quinacridone pigments and carbon black pigments.

The term “dyestuffs forming J-aggregates” as described above mean dyestuffs which form J-aggregates so that the absorption maximum wavelength λmax of the molecule dispersion state in a solution (in a solvent such as dimethylformamide or dimethyl sulfoxide) shifts by 20 nm or more toward the longer wavelength side.

J-Aggregates of dyestuffs are illustrated in detail in “Shashin Katei no Riron”, T. H. James, pages 216 to 222. Among dyestuffs forming J-aggregates, it is preferable to use a dyestuff showing a difference in λmax of 20 nm or more but not more than 150 nm between the molecule dispersion state and the J-aggregates, since an image having improved color hue and color reproducibility can be thus obtained. (It is still preferable to use a dyestuff showing a difference in λmax of 30 nm or more but not more than 120 nm.)

As the dyestuff, use can be made of an arbitrary dyestuff capable of forming J-aggregates. A dyestuff having desired absorption properties may be appropriately selected. For example, use can be made of various dyes listed in Senryo Binran (ed. by Yuki Gosei Kagaku Kyokai, Maruzen, 1978), Chakushokuzai 61[4], pages 215 to 226 (1988) and Kagaku Kogyo, pages 43 to 53 (1986, May) and compounds described in Japanese Patent Application No. 366571/1999.

The average particle size of the water-insoluble colorant preferably ranges from 3 to 500 nm, still preferably from 5 to 300 nm, still preferably from 5 to 150 nm and particularly preferably from 5 to 100 nm. The average particle size can be controlled by, for example, centrifugation or filtration.

Dispersant:

It is necessary that the dispersant can disperse the water-insoluble colorant. The characteristic of the invention resides in that in case where the vinyl monomer alone is polymerized by using the dispersant, the latex thus formed has a poor stability. The term “the stability of latex” as used in the invention means that the aggregation of the polymer scarcely arises in the course of the polymerization and the latex suffers from little aggregation or shows no increase in particle size when subjected to a forced test.

In case where the latex formed by polymerizing the vinyl monomer alone with the use of the dispersant has a high safety, the dispersant has a high affinity for the vinyl monomer or the polymer thus formed. Thus, the dispersant adsorbed on the surface of the water-insoluble colorant dispersion is desorbed and, in its turn, the stability of the dispersion of the water-insoluble colorant is lowered and there arises aggregation (sedimentation and cloudiness). In this case, there arises another undesirable phenomenon that the emulsion polymerization would not proceed on the surface of the dispersion of the water-insoluble colorant and thus polymer particles containing no water-insoluble colorant are formed.

The fact that the latex formed by polymerizing the vinyl monomer alone with the use of the dispersant has a poor safety means that aggregation arises in the course of the polymerization, or even in case where a favorable latex suffering from little aggregation is obtained, solidification or aggregation arises in a forced test (for example, applying a mechanical force as in the Klaxon test or the Marron test, or subjected to a temperature change as in a heating/cooling cycle test).

The frequency of the occurrence of the aggregation in the course of the emulsion polymerization varies depending not only on the combination of the vinyl monomer with the dispersant but also on the vinyl monomer concentration, the dispersant concentration and other additives. In the invention, the stability in the emulsion polymerization is evaluated in the case of polymerizing at a vinyl monomer concentration of 10 to 30% by mass, an addition level of the dispersant of 1 to 5% by mass based on the vinyl monomer and using, as a polymerization initiator, a water-soluble heat initiator (for example, a persulfate, an azo compound) commonly employed in emulsion polymerization.

In case where aggregation arises in the course of the emulsion polymerization and the aggregates amount to 10% or more based on the total polymer obtained, the latex stability is judged as poor.

The forced tests are performed under the following conditions. In a cooling/heating cycle test, a latex having a solid content of 25% is employed and subjected to a cooling/heating cycle (5 hours at 10° C. and 5 hours at 80° C.) twice. In the Marron test, a latex having a solid content of 25% is employed and rotated at a speed of 1000 rpm under a load of 10 kg for 10 minutes.

In case where solidification arises after the forced test, or aggregation arises at a ratio of 5% or more (the ratio of the aggregated polymer to the total polymer solid content), or the center particle size (50% diameter) is 1.2 times longer than the particle size prior to the test, then the emulsion polymerization stability is evaluated as poor.

It is necessary to select an adequate dispersant depending on, for example, the type and the surface polarity of the water-insoluble colorant and the hydrophilic/hydrophobic nature of the vinyl monomer employed. By using an adequate dispersant, the aggregation in the course of the polymerization can be largely lessened and, therefore, the aqueous dispersion of colored fine particles can be efficiently obtained and the particle size can be easily controlled.

As examples of the dispersant, citation may be made of anionic surfactants, nonionic surfactants, cationic surfactants, ampholytic surfactants and polymeric surfactants which will be illustrated in detail hereinbelow.

Examples of the anionic surfactants include fatty acid salts, alkylsulfuric acid salts, alkylsulfuric acid esters, alkylarylsulfonicacidsalts, dialkylsulfosuccinicacidsalts, alkylphosphoric acid ester salts, naphthalenesulfonic acid-formalin condensates and polyoxyethylene alkylsulfuric acid ester salts. Among them, an alkylsulfonic acid derivative, preferably taurine or a derivative thereof, particularly preferably N-acyltaurine compound are used.

Examples of the nonionic surfactants include polyoxyethylene alkyl ethers, polyoxyethylene alkylaryl ethers, polyoxyethylene fatty acid esters, glycerol esters, sorbitan fatty acid esters, polyoxyethylene sorbitan fatty acid esters, polyoxyethylene alkylamines, glycerol fatty acid esters and oxyethylene oxypropylene block copolymers.

Examples of the cationic surfactants include alkyltrimethylammonium chlorides and dialkyldimethylammonium chlorides.

Examples of the ampholytic surfactants include alkyldimethylaminoacetic acid betaines, alkyldimethylamine oxides and alkylcarboxymethylhydroxyethylimidazoloium betaines.

Examples of the polymeric surfactants include synthetic polymers and natural polymers. Examples of the synthetic polymers include polyvinyl alcohols, polyvinyl pyrrolidones, acrylic polymers (for example, polyacrylic acid, acrylic acid-acrylonitrile copolymer, vinyl acetate-acrylicacidester copolymer, acrylic acid-alkyl acrylate copolymer, styrene-acrylic acid copolymer, styrene-methacrylic acid-acrylic acid alkyl ester copolymer, styrene-maleic acid copolymer, vinylnaphthalene-acrylic acid copolymer), fatty acid vinyl ester-based polymers (for example, vinyl acetate-ethylene copolymer, vinyl acetate-maleic acid ester copolymer) and silicone-based polymers (for example, acrylic acid-silicone-containing macromonomer copolymer, polydimethylsiloxane-polyacrylic acid block copolymer).

As the synthetic polymers among the polymeric surfactants as described above, it is particularly preferable to use copolymers composed of a hydrophobic vinyl monomer and a hydrophilic vinyl monomer. It is preferable that these copolymers have a weight-average molecular weight of 1000 to 50000, still preferably 2000 to 40000 and particularly preferably 2000 to 30000.

Examples of the natural polymers among the polymeric surfactants as described above include proteins (for example, flue, gelatin, casein, albumin), natural rubbers (for example, acacia, tragacanth gum), glucosides (for example, saponin), alginic acid derivatives (for example, alginic acid, alginic acid propylene glycol ester, alginic acid triethanolamine), cellulose derivatives (for example, methylcellulose, carboxymethylcellulose, hydroxyethylcellulose, ethylhydroxyethylcellulose).

Aqueous Medium:

The term an “aqueous medium” means water or a mixture of water with a waster-soluble liquid (for example, a water-soluble organic solvent or a water-miscible liquid such as sulfuric acid). It is preferable that water amounts to 50 to 100% in the aqueous medium. The aqueous medium may further contain a water-soluble compound such as an inorganic salt (for example, sodium chloride, lithium hydroxide) dissolved therein.

Components other than water contained in the aqueous medium may be eliminated or reduced by, for example, dialysis or ultrafiltration after dispersing the water-insoluble colorant therein or after forming the aqueous dispersion of the colored fine particles. In case where the component other than water contained in the aqueous medium is an organic solvent essentially required in the ink for ink-jet recording according to the invention, it is unnecessary to eliminate-it.

Vinyl Monomer:

An arbitraryvinyl monomer maybe used as thevinyl monomer, so long as it is usable in the polymerization (for example, emulsion polymerization, suspension polymerization, seed polymerization) for forming fine polymer particles in a conventional aqueous medium system.

As the vinyl monomer, use may be made of a hydrophobic vinyl monomer or a combination of a hydrophobic vinyl monomer with a hydrophilic vinyl monomer. To elevate the dispersion stability of the water-insoluble colorant dispersion, it is favorable to use a combination of a hydrophobic vinyl monomer with a hydrophilic vinyl monomer.

It is preferable that the hydrophobic monomer amounts to from 70 to 100% by mass, still preferably from 70 to 99% by mass and particularly preferably from 80 to 98% by mass, in the total vinyl monomers.

In case of using a hydrophilic vinyl monomer together, the dispersion stability of the aqueous dispersion of the colored fine particles can be further elevated. In case of using in an ink for ink-jet recording, the resultant ink is excellent in the stability with the passage of time and the discharge stability.

The term a hydrophobic vinyl monomer means a vinyl monomer having an I/O value of less than 0.76, preferably an I/O value of 0.05 or more but less than 0.76, still preferably an I/O value of 0.05 or more but less than 0.70, still preferably an I/O value of 0.05 or more but less than 0.60 and particularly preferably an I/O value of 0.05 or more but less than 0.50. It is also possible to use plural hydrophobic monomers in combination.

The term a hydrophilic vinyl monomer means a vinyl monomer having an I/O value of 0.76 or more, preferably an I/O value of 1.0 or more, still preferably an I/O value of 1.4 or more and particularly preferably an I/O value of 1.8 or more. It is also possible to use plural hydrophilic monomers in combination.

Now, the I/O value will be illustrated. The I/O value, namely, a value calculated by dividing an inorganic value by an organic value based on the organic conceptual diagram can be determined by a method described in “Yuki Gainen-zu, Kiso to Oyo”, Yoshio Koda, Sankyo Shuppan (1984).

In the organic conceptual diagram, properties of compounds are classified into inorganic values showing covalent bond properties and inorganic values showing ionic bond properties and every organic compound is located on one point on perpendicular coordinates having an organic axis and an inorganic axis.

The inorganic value means a value which is determined by evaluating the strength of the effect of each substituent on the boiling point based on hydroxyl group, making the distance between the boiling point curve of a linear alcohol and the boiling point curve of a linear paraffin to about 100° C. at around a carbon atom number of 5, and numerically referring the effect of a single hydroxyl group as to 100.

On the other hand, the organic value means a value which is determined by considering the organic value size can be measured with the use of the carbon atom number of an intermolecular methylene which is regarded as a unit, determining the numerical value of a single fundamental carbon atom as 20° C. which is the average of boiling point raising around a carbon atom number of 5 to 10 of a linear compound, and referring it as to 20 as a standard.

These inorganic and organic values are determined in such a manner as to respectively correspond to each other on the graph. The I/O value is calculated from these values. That is to say, “I” stands for the inorganic nature while “O” stands for the organic nature and a higher I/O value indicates the higher inorganic nature.

As the vinyl monomer, use can be made of not only monofunctional vinyl monomers but also polyfunctional vinyl monomers. The term a polyfunctional vinyl monomer means a vinyl monomer having two or more polymerizable double bonds per molecule. By using a polyfunctional vinyl monomer, the polymer coating the surface of the water-insoluble colorant can be crosslinked so that swelling in an aqueous medium or a solvent can be regulated or the dispersion stability of the water-insoluble colorant dispersion can be further improved.

In ink-jet inks which frequently contain water-soluble organic solvents for controlling the physical properties of the inks, it is particularly advantageous to use bifunctional or higher vinyl monomers.

In the total vinyl monomers, the content of the polyfunctional vinyl monomer amounts preferably to 0 to 80% by mass, still preferably 1 to 50% by mass and particularly preferably 3 to 40% by mass.

It is preferable to use the vinyl monomer in an amount of 0.1 to 10 times, still preferably 0.2 to 5 times and particularly preferably 0.5 to 3 times, as much as the water-insoluble colorant. In case where the vinyl monomer is used in a smaller amount, the effects of the invention can be hardly established. In case where it is used in excess, on the other hand, the dispersion of the colored fine particles should be added in an elevated amount to achieve the optimum image density, which is undesirable in designing ink compositions.

In case of employing neither any heat drying treatment after printing nor any heat treatment after drying, the glass transition temperature of the polymer formed by the vinyl monomer preferably ranges from −50° C. to 80° C., still preferably from −50° C. to 70° C. and particularly preferably from −30° C. to 60° C.

In case where the glass transition temperature is excessively high, the fretting resistance is worsened particularly in using photographic image papers. In case where the glass transition temperature is excessively low, on the other hand, the polymer becomes undesirably sticky particularly in using recording media having little ink recipient capacity and little surface unevenness (for example, polymer films). In case where a heating treatment is carried out at from a temperature lower by 20° C. than the glass transition temperature to a temperature higher than the glass transition temperature, then the glass transition temperature may be higher than 80° C.

Next, specific examples of the vinyl monomers will be presented. Each of the aliphatic groups and aromatic groups described hereinbelow may be substituted and examples of the substituents include aliphatic groups, aromatic groups, halogens, cyano group, hydroxy group and alkoxy groups. Ester groups mean the aliphatic and aromatic groups as described above. Examples of the vinyl monomers include: acrylic acid esters and methacrylic acid esters (wherein the ester groups are the aliphatic and aromatic groups as described above, and in case where an ester group can be bonded to plural acryloyl or methacryloyl groups, these esters are polyfunctional acrylates or polyfunctional methacrylates (for example, ethylene glycol dimethacrylate, triethylene glycol, diacrylate, pentaerythritol tetraacrylate, dipentaerythritol hexaacrylate)), aliphatic and aromatic carboxylic acid vinyl esters, acrylamides and methacrylamides (for example, acrylamide, N-monosubstituted acrylamide, N-disubstituted acrylamide, methacrylamide, N-monosubstituted methacrylamide, N-disubstituted methacrylamide, polyfunctional monomers having two or more acryloylamino or methacryloylamino groups (wherein substituents are the aliphatic and aromatic groups as described above)), olefins (for example, ethylene, propylene, 1-butene, 1-pentene, vinyl chloride, vinylidene chloride, isoprene, chloroprene, butadiene, 2,3-dimethylbutadiene), styrenes (for example, styrene, divinylbenzene, substituted styrene), vinyl ethers (more specifically, aliphatic vinyl ethers as described above, aromatic vinyl ethers as described above), other monomers such as acrylonitrile, methacrylonitrile, crotonic acid esters, itaconic acid diesters, maleic acid diesters, fumaric acid diesters, methyl vinyl ketone, phenyl vinyl ketone, N-vinyloxazolidone, N-vinylpyrrolidone, vinylidene chloride, methylene malonnitrile, vinylidene, carboxylic acid monomers such as acrylic acid, methacrylic acid, 2-carboxyethyl acrylate, itaconic acid, maleic acid, fumaric acid, citraconic acid, crotonic acid, itaconic acid monoesters, maleic acid monoesters, sodium acrylate, ammonium methacrylate, potassium itaconate, sulfonic acid monomers such as styrene sulfonic acid, vinyl sulfonic acid, acryloyloxyalkanesulfonic acids (for example, acryloyloxyethanesulfonic acid, acryloyloxypropanesulfonic acid), methacryloyloxyalkanesulfonic acids (for example, methacryloyloxyethanesulfonic acid, methacryloyloxypropanesulfonic acid), acrylamidoalkanesulfonic acids (for example, 2-acrylamido-2-methylpropanesulfonic acid, 2-acrylamido-2-methylbutanesulfonic acid), methacrylamidoalkanesulfonic acids (for example, 2-methacrylamido-2-methylpropanesulfonic acid, 2-methacrylamido-2-methylbutanesulfonic acid), phosphoric acid monomers such as vinylphosphonic acid and methacryloyloxyethanephosphonic acid, monomers having a cationic ionic group, for example, monomers having a tertiary amino group such as dialkyaminoethyl methacrylate and dialkylaminoethyl acrylate, monomers having a nonionic dispersible group such as polyethylene glycol-carboxylic acid monomer esters, polyethylene glycol-sulfonic acid monomer esters, polyethylene glycol-phosphoric acid monomer esters, vinyl-containing urethane formed by polyethylene glycol with isocyanate-containing monomers and macromonomers having a polyvinyl alcohol structure.

The polyethyleneglycols as cited above mean polyethylene glycol monoalkyl ethers and polyethylene glycols having hydroxyl groups at both ends. In case where the polyethylene glycol means polyethylene glycol per se, it is preferable that a vinyl monomer derived therefrom has a polymerizable group exclusively at one end and a hydroxyl group at the other end.

The repeating number of the ethyleneoxy-units in the polyethylene glycols preferably ranges from 5 to 100, still preferably from 5 to 30. In the polyethylene glycols, each alkyl moiety preferably has 1 to 20 carbon atoms, still preferably 1 to 12 carbon atoms.

As the vinyl monomer having an I/O value of 0.05 or more but less than 0.76, styrene or (meth) acrylic ester (an alcohol portion of the ester preferably has 1 to 8 carbon atoms) are preferably used. As the vinyl monomer having an I/O value of 0.76 or more, (meth)acrylic ester, methacrylate of polyethylene oxide monomethyl ether, styrene sulfonic acid or 2-acrylamido-2-methylpropanesulfonic acid are preferably used.

<Preparation of Ink for Ink-Jet Recording>

The ink-jet ink according to the invention contains water, a water-soluble organic solvent and a dispersion of colored fine particles. Now, these components will be specifically illustrated.

Water-Soluble Organic Solvent:

The ink for ink-jet recording according to the invention contains a water-soluble organic solvent as a drying inhibitor and a penetration accelerator.

As the water-soluble organic solvent to be used in the invention, a water-soluble organic solvent having a lower vapor pressure than water is preferable. Specific examples thereof include polyhydric alcohols typified by ethylene glycol, propylene glycol, diethylene glycol, polyethylene glycol, thiodiglycol, dithiodiglycol, 2-methyl-1,3-propanediol, 1,2, 6-hexanetriol, acetylene glycol derivatives, glycerol and trimethylolpropane, polyhydric alcohol lower alkyl ethers such as ethylene glycol monomethyl (or ethyl) ether, diethylene glycol monomethyl (or ethyl) ether and triethylene glycol monoethyl (or butyl) ether, heterocyclic compounds such as 2-pyrrolidone, N-methyl-2-pyrrolidone, 1,3-diethyl-2-imidazolidione and N-ethylmorpholine, sulfur-containing compounds such as sulfolane, dimethyl sulfoxide and 3-sulfolene, and polyfunctional compounds such as diacetone alcohol and diethanolamine. Among them, polyhydric alcohols such as glycerol and diethylene glycol are still preferable. Either one of these water-soluble organic solvents or a combination of two or more thereof may be used. It is preferable that such a water-soluble organic solvent is contained in an amount of 10 to 50% by mass in the ink. Dispersion of colored fine particles:

The content of the dispersion of the colored fine particles in the ink for ink-jet recording preferably ranges from 0.2 to 20% by mass, still preferably from 0.5 to 15% by mass and particularly preferably from 0.5 to 10% by mass.

The average particle size of the dispersion of the colored fine particles preferably ranges from 3 to 500 nm, still preferably from 5 to 300 nm, still preferably from 5 to 150 nm and particularly preferably from 5 to 100 nm. The average particle size can be controlled by, for example, centrifugation or filtration.

Other Additives:

As additives other than the water-soluble organic solvent, the ink may contain, for example, a drying inhibitor for preventing clogging of the ink due to drying at the injection port, a penetration accelerator for facilitating the penetration of the ink into paper, an antioxidant, a viscosity controlling agent, a surface tension controlling agent, a dispersant, a dispersion stabilizer, a mildew-proofing agent, a rust preventive, a pH adjustor, a defoaming agent, a chelating agent or an UV absorber each in an appropriate amount depending on the desired properties.

In addition to the water-soluble organic solvent, urea derivatives may be cited as examples of the drying inhibitor. In addition to the water-soluble organic solvents, use can be made, as the penetration accelerator, of anionic surfactants such as sodium lauryl sulfate and sodium oleate and nonionic surfactants. These additives can achieve sufficient effects at a content of 10 to 30% by mass in the ink. It is desirable to use these additives at such an amount as causing neither blurring of the ink nor print through.

As the antioxidant to be employed for improving image storage properties, use can be made of various organic and metal complex-based fading inhibitors. Examples of the organic fading inhibitors include hydroquinones, alkoxyphenols, dialkoxyphenols, phenols, anilines, amines, indans, chromans, alkoxyanilines and heterocyclic compounds. Examples of the metal complexes include nickel complexes and zinc complexes. More specifically, it is possible to use compounds cited in Research Disclosure No. 17643, columns VII-I to J, ibid. No. 15162, ibid. No. 18716, page 650, left column, ibid. No. 36544, page 527, ibid. NO. 307105, page 872 and ibid. No. 15162, and compounds included in the general formulae of typical compounds and examples of compounds described in Japanese Patent Laid-Open No. No. 215272/1987, pages 127 to 137.

As the surface tension controlling agent, use can be made of nonionic, cationic and anionic surfactants. Examples of the anionic surfactants include fatty acid salts, alkylsulfuric acid ester salts, alkylbenzenesulfonic acid salts, alkylnaphthalenesulfonic acid salts, dialkylsulfosuccinic acid salts, alkylphosphoric acid ester salts, naphthalenesulfonic acid-formalin condensate and polyoxyethylene alkylsulfuric acid ester salts. Examples of the nonionic surfactants include polyoxyethylene alkyl ethers., polyoxyethylene alkyl aryl ethers, polyoxyethylene fatty acid esters, sorbitan fatty acid esters, polyoxyethylene sorbitan fatty acid esters, polyoxyethylene alkylamines, glycerol fatty acid esters and oxyethylene-oxypropylene block copolymers. Also, it is favorable to use SURFYNOLS (Air Products & Chemicals) which are acetylene-type polyoxyethylene oxide surfactants. It is also favorable to use amine oxide-type ampholytic surfactants such as N,N-dimethyl-N-alkylamine oxides. Moreover, use may be made of surfactants cited in Japanese Patent Laid-Open No. No. 157,636/1984, pages (37) to (38) and Research Disclosure No. 308119 (1989).

Because of scarcely causing sedimentation or separation from the ink and having little foaming properties, it is preferable to use anionic surfactants having a double-chain hydrophobic moiety or a branched hydrophobic moiety, anionic surfactants having a hydrophilic group at around the center of a hydrophobic moiety, nonionic surfactants having a double-chain hydrophobic moiety or a branched hydrophobic moiety (for example, polyethylene oxide one-end ester of 2-butyloctanoic acid, polyethylene oxide adduct of undecane-6-ol) or nonionic surfactants having a hydrophilic group at around the center of a hydrophobic moiety (for example, acetylene-type polyoxyethylene oxides). Among all, it is particularly preferable to use those having a molecular weight of 400 or more.

By optionally using these additives, the surface tension of the ink according to the invention is controlled preferably to 20 to 60 mN/m, still preferably 25 to 45 mN/m.

It is preferable that the ink according to the invention has a viscosity of 30 mPa·s or lower. It is still preferable to control its viscosity to 20 mPa·s or lower. To control the viscosity, a viscosity controlling agent is used in some cases. Examples of the viscosity controlling agent include water-soluble polymers such as celluloses and polyvinyl alcohol and nonionic surfactants.

Examples of the mildew-proofing agent to be used in the invention include sodium dehydroacetate, sodium benzoate, sodium pyridinethione-1-oxide, ethyl p-hydroxybenzoate, 1,2-benzisothiazolin-3-one and salts thereof. It is preferable to use such a mildew-proofing agent in an amount of 0.02 to 5.00% by mass in the ink. These mildew-proofing agents are described in greater detail in “Bokin-Bobizai Jiten” (ed. by Nippon Bokin-Bobi Gakkay Henshu Iinkai).

Examples of the rust preventive to be used in the invention include acidic sulfurous acid salts, sodium thiosulfate, ammon thioglycolate, diisopropylammonium nitrite, pentaerythritol tetranitrate, dicyclohexylammonium nitrite andbenzotriazole. It is preferable to use such a rust preventive in an amount of 0.02 to 5.00% by mass in the ink.

The pH adjustor to be used in the invention can be adequately employed for, e.g., adjusting the pH value of the dispersion of the fine particles containing the colorant and imparting dispersion stability thereto. It is preferable to add the pH adjustor so as to give a pH value of 4.5 to 10.0, still preferably 6 to 10.0.

As the pH adjustor, citation may be made of basic ones such as organic bases and inorganic alkalis and acidic ones such as organic acids and inorganic acids.

Examples of the organic bases include triethanolamine, diethanolamine, N-methyldiethanolamine and dimethylethanolamine. Examples of the inorganic alkalis include alkali metal hydroxides (for example, sodium hydroxide, lithium hydroxide, potassium hydroxide), carbonic acid salts (for example, sodium carbonate, sodium hydrogencarbonate) and ammonia.

Examples of the organic acids include acetic acid, propionic acid, trifluoroacetic acid and alkylsulfonic acids. Examples of the inorganic acids include hydrochloric acid, sulfuric acid and phosphoric acid.

If needed, use can be made, as the defoaming agent, of fluorine compounds and silicone compounds and, the chelating agent, compounds typified by EDTA.

As the UV absorbing agent, use can be made of compounds capable of absorbing UV rays and generating fluorescence, i.e., so-called fluorescent whitening agents typified by benzotriazole-type compounds described in, for example, Japanese Patent Laid-Open No. 185677/1983, ibid. No. 19053/1986, Japanese Patent Laid-Open No. 782/1990, ibid. No. 197075/1993 and ibid. No. 34057/1997, benzophenone compounds described in, for example, Japanese Patent Laid-Open No. 2784/1971, Japanese Patent Laid-Open No. 194483/1993 and U.S. Pat. No. 3,214,463, cinnamic acid compounds described in, for example, Japanese Patent Publication No. 30492/1973, ibid. No. 21141/1981 and Japanese Patent Laid-Open No. 88106/1998, triazine compounds described in, for example, Japanese Patent Laid-Open No. 298503/1992, ibid. No. 53427/1996, No. ibid. 239368/1996, ibid. No. 18261/1998 and International Patent Publication No. 501291/1996, compounds described in Research Disclosure No. 24239, stilbene compounds and benzoxazole compounds.

The ink for ink-jet recording according to the invention is usable in forming not only monochrome images but also full-color images. To form full-color images, use can be made of a magenta color ink, a cyanogene color ink and a yellow color ink. To control the color tone, use may be further made of a black color ink. It is preferable that at least one of these color inks having various color hues is the ink for ink-jet recording according to the invention, since a full-color image with a favorable color hue can be thus formed. It is still preferable that all of these color inks are the inks for ink-jet recording according to the invention, since a full-color image with an excellent color hue can be thus formed.

Image Receptor Material:

Examples of an image receptor material to be used in the ink-jet recording method with the use of the ink according to the invention include ordinary papers, coated papers and plastic films. It is preferable to use coated papers as the image receptor material, since the image qualities and the image preservation durability can be thus improved.

The ink according to the invention can be used in forming images on publicly known recording materials, for example, ordinary papers, resin-coated papers, papers exclusively used for ink-jet printing such as those described in Japanese Patent Laid-Open No. 169172/1996, ibid. No. 27693/1996, ibid. No. 276670/1990, ibid. No. 276789/1995, ibid. No. 323475/1997, ibid. No. 238783/1987, ibid. No. 153989/1998, ibid. No. 217473/1998, ibid. No. 235995/1998, ibid. No. 337947/1998, ibid. No. 217597/1998 and ibid. No. 337947/1998, papers also usable in electrophotography, fabrics, glasses, metals and ceramics.

Next, recording papers and recording films to be used in ink-jet printing with the use of the ink according to the invention will be illustrated. As the substrate in the recording papers and recording films, use can be made of products which are made of chemical pulps (for example, LBKP, NBKP), mechanical pulps (for example, GP, PGW, RMP, TMP, CTMP, CMP, CGP), or waste paper pulps (for example, DIP) and obtained by mixing, if needed, publicly known additives such as pigments, binders, sizing agents, fixative agents, cationic agents and paper strengthening agents and processing the resultant mixture with various devices such as a long net paper machine or a round net paper machine. In addition to these substrates, use may be also made of synthetic papers or plastic sheets. The thickness of the substrate preferably ranges from 10 to 250 μm, while its basis weight preferably ranges from 10 to 250 g/m². The substrate may be provided with an ink-receiving layer and a back coat layer as such. Alternatively, it may be provided with a size press or an anchor coat layer by using, for example, starch or polyvinyl alcohol and then the ink-receiving layer and the back coat layer may be formed. The substrate may be further flattened by using a calendering machine such as a machine calender, a TG calender or a soft calender. In the invention, it is preferable to use, as the substrate, a paper or a plastic film having a polyolefin (for example, polyethylene, polystyrene, polyethylene terephthalate, polybutene, copolymers thereof) laminated on both faces. It is still preferable to add a white pigment (for example, titanium oxide, zinc oxide) or a coloring dye (for example, cobalt blue, ultramarine, neodymium oxide) to the polyolefin.

The ink-receiving layer formed on the substrate contains a pigment and an aqueous binder. As the pigment, it is preferable to use a white pigment. Examples of the white pigment include inorganic white pigments such as calcium carbonate, kaolin, talc, clay, diatomaceous earth, synthetic amorphous silica, aluminum silicate, magnesium silicate, calcium silicate, aluminum hydroxide, alumina, lithopone, zeolite, barium sulfate, calcium sulfate, titanium dioxide, zinc sulfide and zinc carbonate, and organic pigments such as styrene-based pigments, acrylic pigments, urea resins and melamine resins. As the white pigment contained in the ink-receiving layer, it is preferable to use a porous inorganic pigment. Synthetic amorphous silica having a large pore area is particularly appropriate therefor. Although dry silicic acid obtained by the dry production method and water-containing silicic acid obtained by the wet production method are both usable as the synthetic amorphous silica, it is particularly preferable to use the water-containing silicic acid. It is also possible to use two or more of these pigments together.

Examples of the aqueous binder contained in the ink-receiving layer include water-soluble polymers such as polyvinyl alcohol, silanol-denatured polyvinyl alcohol, starch, cationized starch, casein, gelatin, carboxymethylcellulose, hydroxyethylcellulose, polyvinyl pyrrolidone, polyalkylene oxides and polyalkylene oxide derivatives, and water-dispersible polymers such as styrene-butadiene latex and acryl emulsion. Either one of these aqueous binders or a combination of two or more thereof may be used. Among all, it is appropriate in the invention to use polyvinyl alcohol and silanol-denatured polyvinyl alcohol from the viewpoints of the adhesiveness to the pigment and the peeling resistance of the ink-receiving layer.

In addition to the pigment and the aqueous binder as described above, the ink-receiving layer may contain a mordant, a water-proofing agent, a light-fastness improving agent, a surfactant, a hardener and other additives.

It is preferable that the mordant to be added to the ink-receiving layer has been immobilized. Accordingly, it is preferable to use a polymer mordant.

Polymer mordants are described in Japanese Patent Laid-Open No. 28325/1973, ibid. No. 74430/1979, ibid. No. 124726/1979, ibid. No. 22766/1980, ibid. No. 142339/1980, ibid. No. 23850/1985, ibid. No. 23851/1985, ibid. No. 23852/1985, ibid. No. 23853/1985, ibid. No. 57836/1985, ibid. No. 60643/1985, ibid. No. 118834/1985, ibid. No. 122940/1985, ibid. No. 122941/1985, ibid. No. 122942/1985, ibid. No. 235134/1985, ibid. No. 161236/1989, U.S. Pat. No. 2,484,430, ibid. U.S. Pat. No. 2,548,564, ibid. U.S. Pat. No. 3,148,061, ibid. U.S. Pat. No. 3,309,690, ibid. U.S. Pat. No. 4,115,124, ibid. U.S. Pat. No. 4,124,386, ibid. U.S. Pat. No. 4,193,800, ibid. U.S. Pat. No. 4,273,853, ibid. U.S. Pat. No. 4,282,305 and ibid. U.S. Pat. No. 4,450,224. Image receptor materials containing the polymer mordants described in Japanese Patent Laid-Open No. 161236/1989, pages 212 to 215. By using the polymer mordants described in-this document, images having excellent image qualities can be obtained and the light-fastness of the images can be improved.

The water-proofing agent is efficacious in imparting water-proofness to images. Cationic resins are particularly preferable as the water-proofing agent. Examples of the cationic resins include polyamide polyamine epichlorhydrin, polyethylene imine, polyamine sulfone, dimethyldiarylammonium chloride polymer, cation polyacrylamide and colloidal silica. Among these cationic resins, polyamide polyamine epichlorhydrin is particularly preferable. The content of the cationic resin preferably ranges from 1 to 15% by mass, still preferably from 3 to 10% by mass, based on the total solid content of the ink-receiving layer.

Examples of the light-fastness improving agent include zinc sulfate, zinc oxide, hindered amine-type antioxidants and bezophenone-type and benzotriazole-type UV absorbers. Among all, zinc sulfate is appropriate therefor.

The surfactant serves as a coating aid, a release improving agent, a slipperiness improving agent or an antistatic agent. Surfactants are described in detail in Japanese Patent Laid-Open No. 173463/1987 and ibid. No. 183457/1987.

As a substitute for the surfactant, use may be made of an organic fluoro compound. It is preferable that the organic fluoro compound has a hydrophobic nature. Examples of the organic fluoro compound include fluorine-based surfactants, oily fluorine-based compounds (for example, fluorine oil) and solid fluorine-based compounds (for example, ethylene tetrafluoride resin). Organic fluoro compounds are described in Japanese Patent Publication No. 0953/1982 (column 8 to 17), Japanese Patent Laid-Open No. 20994/1986 and ibid. No. 135826/1987.

As the hardener, use can be made of, for example, materials described in Japanese Patent Laid-Open No. 161236/1989.

Examples of other additives to be added to the ink-receiving layer include a pigment dispersant, a thickener, a defoaming agent, a dye, a fluorescent whitener, a preservative, a pH adjustor, a matting agent and a hardener. The ink-receiving layer may be composed of either a single layer or two layers.

The recording paper or the recording film can be provided with aback coat layer. This layer may contain a white pigment, an aqueous binder and other components. Examples of the white pigment contained in the back coat layer include inorganic white pigments such as light calcium carbonate, heavy calcium carbonate, kaolin, talc, calcium sulfate, barium sulfate, titanium dioxide, zinc oxide, zinc sulfate, zinc carbonate, stain white, aluminum silicate, diatomaceous earth, calcium silicate, magnesium silicate, synthetic amorphous silica, colloidal silica, colloidal alumina, pseudo-boehmite, aluminum hydroxide, lithopone, zeolite, water-containing halloysite, magnesium carbonate and magnesium hydroxide, and organic pigments such as styrene-based pigments, acrylic pigments, polyethylene, microcapsules, urea resins and melamine resins.

Examples of the aqueous binder contained in the back coat layer include water-soluble polymers such as styrene-maleic acid salt copolymer, styrene-acrylic acid salt copolymer, polyvinyl alcohol, silanol-denatured polyvinyl alcohol, starch, cationized starch, casein, gelatin, carboxymethylcellulose, hydroxyethylcellulose and polyvinyl pyrrolidone, and water-dispersible polymers such as styrene-butadiene latex and acryl emulsion. Examples of the other components contained in the back coat layer include a defoaming agent, a foaming controller, a dye, a fluorescent whitener, a preservative and a water-proofing agent.

A polymer latex may be added to layers (involving the back coat layer) constituting the ink-jet recording paper and recording film. The polymer latex is employed in order to improve the film properties including dimensional stability, curling resistance, adhesion resistance and cracking resistance. Polymer latexes are described in Japanese Patent Laid-Open No. 245258/1987 and ibid. No. 110066/1987. By adding a polymer latex having a low glass transition temperature (40° C. or lower) to a layer containing the mordant, cracking or curling of the layer can be prevented. By adding a polymer latex having a high glass transition temperature to the back layer, it is also possible to prevent curling.

The ink according to the invention is usable in any ink-jet recording methods without restriction, for example, publicly known systems such as the charge controlling system wherein an ink is discharged by using an electrostatic induction power, the drop-on-demand system (pressure pulse system) with the use of the oscillation pressure of a piezoelectric element, the acoustic ink-jet system wherein an electrical signal is converted into an acoustic beam and an ink is irradiated therewith and thus discharged under the radiation pressure, and the thermal ink-jet (bubble-jet) system wherein an ink is heated to form bubbles and the pressure thus generated is employed.

The ink-jet recording methods include a system in which an ink having a low concentration (i.e., a photoink) is injected in a large number of droplets having a small volume unit, another system wherein plural inks having substantially the same color hue but different concentrations are used to improve image qualities, and still another system with the use of a colorless and transparent ink.

### EXAMPLES

The invention will be illustrated in greater detail by reference to the following examples. However, it is to be understood that the invention is not construed as being restricted thereto.

### Comparative Example 1

<Preparation of Aqueous Dispersion 50 of Colored Fine Particles>

The following composition was dispersed by mixing in a sand grinder mill at 1200 rpm for 6 hours to obtain a dispersion of the water-insoluble colorant.

| | | |
|---|---|---|
| water-insoluble colorant (C.I. Pigment Red 122.) | 11.7 | g |
| styrene | 22.2 | g |
| methacrylic acid | 1.2 | g |
| zirconia beads (diameter: 0.3 mm) | 200 | g |

The particle size was 3.6 μm (measured with a Microtrac UPA150 manufactured by Honeywell). To 3.8 g of the dispersion thus obtained were added 0.25 g of a dispersant (D-1) and 46 g of water. After adding 40 mg of a water-soluble radical polymerization initiator (4,4′-azobis(4-cyanopentanoic acid)), the resultant mixture was polymerized in a nitrogen atmosphere under stirring at 73° C. for 4 hours and then at 80° C. for 4 hours. As a result, aggregation largely occurred. After filtering through a 0.4 μm filter, the obtained filtrate was almost clear. Thus no aqueous dispersion of colored fine particles could be obtained.

Thus, it is found out that, by the method wherein a pigment is added to a vinyl monomer and then a surfactant and water are further added followed by emulsion polymerization, the pigment can be hardly finely milled and, moreover, can be scarcely stabilized in the course of the emulsion polymerization, thereby frequently causing aggregation. This is seemingly because the pigment has a large particle size and the dispersant cannot be sufficiently adsorbed on the pigment surface coated with the vinyl monomer so that stabilization cannot be established.

### Example 1

<Preparation of Aqueous Dispersion 01 of Colored Fine Particles>

The following composition was dispersed by mixing in a sand grinder mill at 1200 rpm for 6 hours to obtain a dispersion of the water-insoluble colorant.

| | | |
|---|---|---|
| water-insoluble colorant (C.I. Pigment Red 122.) | 11.7 | g |
| dispersant (D-1) | 2.3 | g |
| water | 61 | g |
| zirconia beads (diameter: 0.3 mm) | 400 | g |

The particle size was 77 nm (measured with a Microtrac UPA150 manufactured by Honeywell). To 8.0 g of the dispersion of the water-insoluble colorant thus obtained were added vinyl monomers (styrene 1.19 g, methacrylic acid 0.06 g) and 40 mg of a water-soluble radical polymerization initiator (4,4′-azobis(4-cyanopentanoic acid)). Further, water was added thereto to give a total weight of 50 g. The resultant mixture was polymerized in a nitrogen atmosphere under stirring at 73° C. for 4 hours and then at 80° C. for 4 hours and then filtered through a 0.4 μm filter to thereby give a dispersion of colored fine particles. The particle size was 92 nm and the yield was 95%. By observing under a TEM (transmission electron microscope), it was confirmed that the water-insoluble colorant was coated with the polymer.

Although the dispersant D-1 is excellent in dispersing a water-insoluble colorant, it has a poor polymerization suitability in case where a vinyl monomer mixture is polymerized alone. Owing to these characteristics, the dispersion of the fine particles composed of the surface-coated pigment could be obtained at a high yield without causing aggregation. This is seemingly because, in the emulsion polymerization with the water-insoluble colorant dispersion, the dispersant was scarcely desorbed from the pigment surface because of the not so high affinity for the vinyl monomers and the polymer and, therefore, the polymerization proceeded on the pigment surface on which the dispersant was adsorbed.

<Preparation of Aqueous Dispersions 02 to 16 of Colored Fine Particles>

Aqueous dispersions 02 to 16 of colored fine particles were prepared each as in the preparation of the aqueous dispersion 01 of the colored fine particles as described above but changing the water-insoluble colorant, the dispersant and the vinyl monomers as listed in Table 1.

| | Water- | | Suitability | Particle | | Particle | | | |
|---|---|---|---|---|---|---|---|---|---|
| Ex. | insoluble | Dis- | for homopoly- | size | Vinyl monomer | size | Aggre- | Yield | |
| no. | Colorant | persant | merization | (nm)1) | (I/O value) | (nm)2) | gation | (%)4) | Note |
| 01 | C.I. Pigment | D-1 | Poor | 77 | styrene (0.09) 1.19 g, | 92 | No | 95 | Invention |
| | Red 122. | | | | methacrylic acid (1.88) | | | | |
| | | | | | 0.06 g | | | | |
| 02 | C.I. Pigment | D-1 | Poor | 77 | butyl acrylate (0.43) 1.19 g, | 94 | No | 97 | Invention |
| | Red 122. | | | | acrylic acid (2.50) 0.06 g | | | | |
| 03 | C.I. Pigment | D-1 | Poor | 77 | butyl methacrylate (0.38) | 101 | No | 94 | Invention |
| | Red 122. | | | | 1.79 g, PEO23MA³⁾ (1.82) | | | | |
| | | | | | 0.12 g | | | | |
| 04 | C.I. Pigment | D-1 | Poor | 77 | isobutyl methacrylate | 95 | No | 95 | Invention |
| | Red 122. | | | | (0.38) 1.19 g, methacrylic | | | | |
| | | | | | acid (1.88) 0.06 g | | | | |
| 05 | C.I. Pigment | D-1 | Poor | 77 | styrene (0.09) 1.19 g, | 104 | No | 93 | Invention |
| | Red 122. | | | | 2-ethylhexyl acrylate | | | | |
| | | | | | (0.27) 1.19 g, acrylic acid | | | | |
| | | | | | (2.50) 0.12 g | | | | |
| 06 | C.I. Pigment | D-1 | Poor | 77 | cyclohexyl methacrylate | 92 | No | 95 | Invention |
| | Red 122. | | | | (0.35) 1.19 g, acrylic acid | | | | |
| | | | | | (2.50) 0.06 g | | | | |
| 07 | C.I. Pigment | D-2 | Poor | 67 | benzyl methacrylate (0.34) | 93 | No | 94 | Invention |
| | Red 122. | | | | 1.2 g, butyl acrylate (0.43) | | | | |
| | | | | | 1.0 g, N-vinyl pyrrolidone | | | | |
| | | | | | (1.75) 0.2 g, acrylic acid | | | | |
| | | | | | (2.50) 0.1 g) | | | | |
| 08 | C.I. Pigment | D-1 | Poor | 77 | butyl acrylate (0.43) 1.79 g, | 118 | No | 92 | Invention |
| | Red 122. | | | | butyl methacrylate (0.38) | | | | |
| | | | | | 1.79 g, methacrylic acid | | | | |
| | | | | | (1.88) 0.12 g | | | | |
| 09 | C.I. Pigment | D-3 | Good | 76 | styrene (0.09) 1.19 g, | 354 | Much | 32 | Comparison |
| | Red 122. | | | | methacrylic acid (1.88) | | | | |
| | | | | | 0.06 g | | | | |
| 10 | C.I. Pigment | D-4 | Good | 79 | styrene (0.09) 1.19 g, | Aggre- | Very | 5 | Comparison |
| | Red 122. | | | | methacrylic acid (1.88) | gation | much | | |
| | | | | | 0.06 g | | | | |
| 11 | C.I. Pigment | D-1 | Poor | 70 | butyl acrylate (0.43) | 90 | No | 97 | Invention |
| | Blue 15:3 | | | | 1.19, ethylene glycol | | | | |
| | | | | | dimethacrylate (0.60) 0.2 g, | | | | |
| | | | | | acrylic acid (2.50) 0.06 g | | | | |
| 12 | C.I. Pigment | D-1 | Poor | 70 | butyl methacrylate (0.38) | 91 | No | 93 | Invention |
| | Blue 15:3 | | | | 1.79 g, PEO23MA (1.82) | | | | |
| | | | | | 0.12 g, methacrylic acid | | | | |
| | | | | | (1.88) 0.04 g | | | | |
| 13 | C.I. Pigment | D-1 | Poor | 70 | styrene (0.09) 1.19 g, | 86 | No | 98 | Invention |
| | Blue 15:3 | | | | divinylbenzene (0.10) | | | | |
| | | | | | 0.12 g, styrenesulfonic | | | | |
| | | | | | acid (1.19) 0.12 g | | | | |
| 14 | C.I. Pigment | D-1 | Poor | 74 | butyl acrylate (0.43) 1.19 g, | 92 | No | 92 | Invention |
| | Yellow 128 | | | | acrylic acid (2.50) 0.06 g | | | | |
| 15 | C.I. Pigment | D-3 | Good | 78 | butyl acrylate (0.43) 1.19 g, | Aggre- | Very | 9 | Comparison |
| | Yellow 128 | | | | acrylic acid (2.50) 0.06 g | gation | Much | | |
| 16 | C.I. Pigment | D-1 | Poor | 77 | styrene (0.09) 1.25 g | 93 | Little | 75 | Invention |
| | Red 122 | | | | | | | | |

1)Particle size of water-insoluble colorant dispersion.
2)Particle size of aqueous dispersion of colored fine particles.
³⁾PEO23MA: methacrylate of polyethylene oxide (repeating unit:23) monomethyl ether.
4)Determined from theoretical value of recovered solid matters.

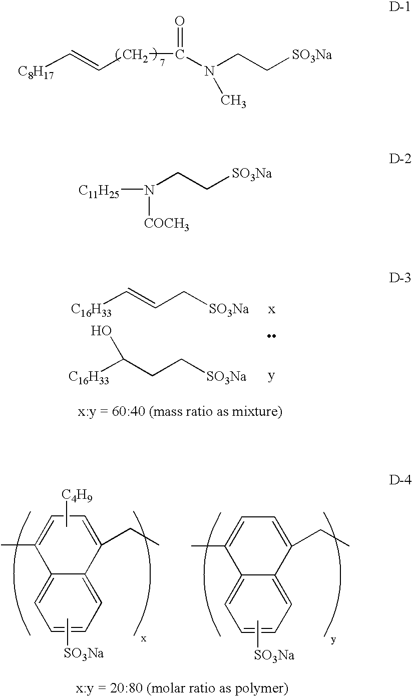

The term “Suitability for homopolymerization” as used in Table 1 means the dispersion stability of the latex formed by polymerizing the vinyl monomer in the presence of a dispersant free from any water-insoluble colorant.

The evaluation as “Poor” as used in Table 1 means a case wherein the aggregates (agglutinates) amount is 10% or more in the total polymer in the course of the emulsion polymerization, or a case wherein, when little aggregation arises, then solidification (gelation) occurs at a ratio of 5% or more, or the center particle size is 1.2 times or more longer than the particle size prior to the test after repeating the cooling/heating cycle (5 hours at 10° C. and 5 hours at 80° C.) twice.

The evaluation as “Good” in Table 1 means a case wherein the aggregates amount is less than 10% in the total polymer in the course of the emulsion polymerization and solidification (gelation) would not occur at a ratio of 5% or more, or the center particle size is not 1.2 times or more longer than the particle size prior to the test after repeating the cooling/heating cycle (5 hours at 10° C. and 5 hours at 80° C.) twice.

As the results given in Table 1 show, the cases with the use of the dispersants D-3 and D-4, which are excellent in the suitability of the homopolymerization of the vinyl monomer, the particle sizes of the water-insoluble colorant dispersions are almost comparable to those of the cases with the use of the dispersant D-1 and D-2. Thus, the pigment dispersion may be regarded as favorable in the former cases. However, the particle sizes of the aqueous dispersions of the colored fine particles were enlarged or aggregation arose in the former cases. Namely, aggregation frequently arose in the production of the dispersions of the colored fine particles.

In Example 16 wherein no monomer having an I/O value of 0.76 or more was contained, the yield was lowered due to the aggregation arising during the polymerization, which indicates that it is favorable to use a monomer having an I/O value of 0.76 or more together.

### Example 2

<Preparation of Ink 01>

Using the aqueous dispersion of the colored fine particles obtained in Example 1, an ink for ink-jet recording (ink 01) of the following composition was prepared and filtered through a 0.4 μm filter.

| | | |
|---|---|---|
| aqueous dispersion 01 of colored fine particles | 12.5 | g |
| ethylene glycol | 1.3 | g |
| glycerol | 1.3 | g |
| SURFYNOL 465 | 0.15 | g |
| one-end 2-butyloctanoic acid ester of polyethylene gly- | 0.10 | g |
| col (average repeating number of ethylene oxide: 10) | | |
| water | suffice to 25 | g |

<Preparations of Inks 02 to 12>

Inks 02 to 12 for ink-jet recording were prepared each as in the preparation of the ink 01 as described above but changing the water-insoluble colorant as listed in Table 2.

<Preparation of Ink 20>

The following composition was dispersed by mixing in a sand grinder mill at 1200 rpm for 6 hours to obtain a dispersion of the water-insoluble colorant.

| | | |
|---|---|---|
| water-insoluble colorant (C.I. Pigment Red 122.) | 11.7 | g |
| dispersant (D-1) | 2.3 | g |
| water | 61 | g |
| zirconia beads (diameter: 0.3 mm) | 400 | g |

The particle size was 86 nm (measured with a Microtrac UPA150 manufactured by Honeywell). Using the aqueous dispersion of the colored fine particles thus obtained, a liquid for ink-jet recording of the following composition was prepared and filtered through a 0.4 μm filter.

| | | |
|---|---|---|
| dispersion of water-insoluble colorant | 12.5 | g |
| ethylene glycol | 1.3 | g |
| glycerol | 1.3 | g |
| SURFYNOL 465 | 0.15 | g |
| one-end 2-butyloctanoic acid ester of polyethylene gly- | 0.10 | g |
| col (average repeating number of ethylene oxide: 10) | | |
| water | suffice to 25 | g |

Image Recording and Evaluation:

The inks 01 to 20 thus prepared were each filled into the cartridge of an ink-jet printer Model PM-770C (manufactured by EPSON). By using this printer, images were recorded on ordinary PPC paper and ink-jet paper photo-gloss paper EX (manufactured by Fuji Photo Film) and evaluated as follows. Table 2 summarizes the results.

<Tg of Vinyl Polymer>

The Tg of the vinyl polymer alone free from any colorant was measured with DSC.

<Dispersion Stability>

After heating the ink to 60° C. under sealed conditions for 4 days, the conditions of the liquid were observed. Further, the particle size ratio was measured and evaluation was made according to the following criteria.

Particle size ratio = particle size after heating/particle size after heating

| | |
|---|---|
| A: | showing no sedimentation or cloudiness and particle size |
| | ratio of less than 1.1. |
| B: | showing no sedimentation or cloudiness and particle size |
| | ratio of less than 1.3. |
| C: | showing no sedimentation or cloudiness. |

<Evaluation of Printing Performance>

The cartridge was set to the printer and it was confirmed that the ink was discharged from all nozzles. Then images were output on five A4 paper sheets and printing failures were evaluated in accordance with the following criteria.

| | |
|---|---|
| A: | showing no printing failure from the initiation to the |
| | termination of the printing. |
| B: | showing printing failures sometimes from the initiation |
| | to the termination of the printing. |
| C: | showing printing failures from the initiation to the |
| | termination of the printing. |

<Evaluation of Paper-Dependence>

The color tone of the image formed on the photo gloss paper was compared with the color tone of the image formed on the ordinary PPC paper. Then evaluation was made in the following three grades: A: showing scarcely any difference between both images; B: showing a little difference between both images; and C: showing a large difference between both images.

<Evaluation of Water-Proofness>

The photo gloss paper on which the image had been formed was dried at room temperature for 1 hour and then immersed in water for 30 seconds. After spontaneously drying at room temperature, blurring was observed and evaluated in the following three grades: A: no blurring; B: blurring; and C: seriously blurring.

<Evaluation of Light-Fastness>

The photo gloss paper on which the image had been formed was irradiated with xenon light (85000 lx) for seven days by using a weatherometer (Model Atlas C.I65). The image density was measured with a reflection densitometer (Model X-Rite 310TR) before and after the irradiation with xenon and evaluated as the dyestuff residual ratio.

Then evaluation was made in the following three grades: A: showing dyestuff residual ratio of 90% or more; B: showing dyestuff residual ratio of 80% or more but less than 90%; and C: showing dyestuff residual ratio of less than 80%.

<Evaluation of Fretting Resistance>

The photo gloss paper on which the image had been formed was dried at room temperature for 1 hour and then rubbed back and forth five times with a plastic eraser. Then fading was observed and evaluated in the following three grades: A: scarcely showing any fading, B: showing some fading with little white background; and C: showing serious fading with much white background.

<Metallic Luster>

The metallic luster (bronze) of the photo gloss paper on which the image had been formed was observed with the naked eye and evaluated in the following three grades: A: scarcely showing any metallic luster; B: showing a little metallic luster; and C: obviously showing metallic luster.

TABLE 2

| | Aqueous | | | | | | | | | |
|---|---|---|---|---|---|---|---|---|---|---|
| | dispersion | Tg of | | | | | | | | |
| | of colored | vinyl | | | | | | | | |
| Ink | fine | polymer | Dispersion | Printing | Paper- | Water- | Light- | Fretting | Metallic | |
| no. | particles | (° C.) | stability | performance | dependency | proofness | fastness | resistance | luster | Note |
| 01 | 01 | 102 | A | A | A | A | A | B | A | Invention |
| 02 | 02 | −51 | A | A | A | A | A | A | A | Invention |
| 03 | 03 | 21 | A | A | A | A | A | A | A | Invention |
| 04 | 04 | 53 | A | A | A | A | A | A | A | Invention |
| 05 | 05 | 13 | A | A | A | A | A | A | A | Invention |
| 06 | 06 | 85 | A | A | A | A | A | B | A | Invention |
| 07 | 07 | 9 | A | A | A | A | A | A | A | Invention |
| 08 | 08 | −20 | A | A | A | A | A | A | A | Invention |
| 09 | 11 | −48 | A | A | A | A | A | A | A | Invention |
| 10 | 14 | 21 | A | A | A | A | A | A | A | Invention |
| 11 | 16 | 102 | B | B | A | A | A | B | A | Invention |
| 12 | 09 | 102 | C | C | A | A | A | C | B | Comparison |
| 20 | — | — | A | A | A | A | A | C | C | Comparison |

As the results given in Table 2 clearly show, the inks for ink-jet recording of Examples are excellent in dispersion stability and printing suitability, show no paper-dependency and little metallic luster and have excellent water-proofness, light-fastness and fretting resistance. Since the most favorable fretting resistance cannot be achieved in the products wherein the vinyl polymer coating the surface of the water-insoluble colorant has a Tg higher than 80° C., it is preferable that the Tg is 80° C. or lower in case of performing no heat drying after printing. The products containing components having an I/O value of 0.76 or more are particularly excellent in dispersion stability and printing suitability.

The invention can provide dispersions of colored fine particles which have a small particle size of the dispersed particles and are excellent in the dispersion stability and storage stability of the dispersion in a dispersing medium without resort to the step of finely milling the monomer oil droplets in the course of the emulsion polymerization. By using these dispersions colored fine particles, it is also possible to provide inks for ink-jet recording which are excellent in dispersion stability, printing performance and fretting resistance and show little metallic luster.

This application is based on Japanese Patent application JP 2002-11645, filed Jan. 21, 2002, the entire content of which is hereby incorporated by reference, the same as if set forth at length.

What is claimed is:

1. An aqueous dispersion of colored particles, the dispersion comprising:
a water-insoluble colorant;
an aqueous medium;
a polymer obtained by a vinyl monomer; and
a dispersant,
wherein the dispersion has a high dispersion stability when the water-insoluble colorant is dispersed in the presence of the dispersant, and a latex having a poor dispersion stability is formed when the vinyl monomer is polymerized in the presence of the dispersant alone.

2. The aqueous dispersion according to claim 1, wherein the vinyl monomer comprises a component having an I/O value of 0.05 or more but less than 0.76 and 2 to 30% by weight of a component having an I/O value of 0.76 or more.

3. The aqueous dispersion according to claim 1, wherein the polymer has a glass transition temperature of −50 to 80° C.

4. The aqueous dispersion according to claim 2, wherein the vinyl monomer having an I/O value of 0.05 or more but less than 0.76 is at least one kind of monomers selected from the group consisting of styrene, acrylic ester and methacrylic ester; and the vinyl monomer having an I/O value of 0.76 or more is at least one kind of monomers selected from the group consisting of acrylic ester, methacrylic ester, methacrylate of polyethylene oxide monomethyl ether, styrene sulfonic acid and 2-acrylamido-2-methylpropanesulfonic acid.

5. The aqueous dispersion according to claim 1, wherein the dispersant is a taurine compound.

6. A process for producing an aqueous dispersion of colored particles, the dispersion comprising a water-insoluble colorant, and the process comprises:
dispersing the water-insoluble colorant in an aqueous medium in the presence of a dispersant;
adding a vinyl monomer after the dispersing to form a mixture; and
polymerizing the mixture,
wherein the dispersion has a high dispersion stability when the water-insoluble colorant is dispersed in the presence of the dispersant, and a latex having a poor dispersion stability is formed when the vinyl monomer is polymerized in the presence of the dispersant alone.

7. An ink for ink-jet recording comprising water, a water-soluble organic solvent and a dispersion of colored particles, the dispersion comprising:
a water-insoluble colorant;
an aqueous medium;
a polymer obtained by a vinyl monomer; and
a dispersant,
wherein the dispersion has a high dispersion stability when the water-insoluble colorant is dispersed in the presence of the dispersant, and a latex having a poor dispersion stability is formed when the vinyl monomer is polymerized in the presence of the dispersant alone.

8. The ink according to claim 7, which further comprises a nonionic surfactant.

9. The ink according to claim 7, wherein the vinyl monomer comprises a component having an I/O value of 0.05 or more but less than 0.76 and 2 to 30% by weight of a component having an I/O value of 0.76 or more.

10. An ink-jet recording method comprising recording with the use of the ink according to claim 7.

11. An ink-jet recording method comprising recording with the use of the ink according to claim 8.

12. An ink-jet recording method comprising recording with the use of the ink according to claim 9.
